(19) United States
(12) Patent Application Publication
(10) Pub. No.: US 2025/0036541 A1
(43) Pub. Date: Jan. 30, 2025

(54) METHOD FOR HEALTH EVALUATION BASED ON INTELLIGENT OPERATION AND MAINTENANCE SCENARIOS, AND DEVICE THEREOF

(71) Applicants: INSTITUTE OF INFORMATION ENGINEERING, CHINESE ACADEMY OF SCIENCES, Beijing (CN); National Computer Network Emergency Response Technical Team/Coordination Center of China, Beijing (CN)

(72) Inventors: Rong YANG, Beijing (CN); Chengli XIE, Beijing (CN); Yang LIU, Beijing (CN); Chengyu GUO, Beijing (CN); Lei WANG, Beijing (CN); Hongwei WU, Beijing (CN); Fengmei WANG, Beijing (CN); Zhuojun JIANG, Beijing (CN); Qingyun LIU, Beijing (CN)

(21) Appl. No.: 18/578,497

(22) PCT Filed: Jul. 14, 2023
(86) PCT No.: PCT/CN2023/107490

§ 371 Date: Jan. 11, 2024

(30) Foreign Application Priority Data
Aug. 3, 2022 (CN) 202210926827.X

(51) Int. Cl. G06F 11/34

(52) U.S. Cl. CPC G06F 11/3476

(57) ABSTRACT

The invention discloses a method for health evaluation based on intelligent operation and maintenance scenarios, and a device thereof. The method includes: collecting log data and configuration data of the operation and maintenance system; preprocessing the log data and the configuration data to build a business key information database; and training the vector autoregressive model and the LSTM-AE model respectively based on the data and labels of configuration id in each set time interval to obtain the vector autoregressive model anomaly score and the LSTM-AE model anomaly score of each configuration id at the prediction time; obtaining the anomaly score of the configuration id at the prediction time by synthesizing the vector autoregression of the configuration id at the prediction time and the model anomaly score and the LSTM-AE model anomaly score; calculating the health degree of the operation and maintenance system at the prediction time based on the anomaly score of each configuration id at the prediction time. The present invention realizes the health assessment of intelligent operation and maintenance scenarios.

### TECHNICAL FIELD

The present invention relates to the field of system health evaluation systems, and in particular to a method for health evaluation based on intelligent operation and maintenance scenarios, and a device thereof.

### BACKGROUND ARTS

With the rapid development of the Internet and the continuous enhancement of the business capabilities of intelligent operation and maintenance systems, the system is rapidly developing in the direction of architectural heterogeneity, logic complexity, and indicator diversification. However, the status monitoring of the system's business data still uses manual monitoring, which requires high experience and technical requirements for operators, and usually cannot quickly detect abnormalities and find the problem, resulting in a long time interval from the occurrence of the exception to the repair of the exception. It is relatively long, which seriously affects the reliable and stable operation of the business, and the overall health and reliability of the system cannot be effectively evaluated.

Due to the complex coupling relationships that exist within various business systems, there is still a single evaluation method for the evaluation of the overall health status of the system, a lack of multi-dimensional and three-dimensional evaluation methods, and a lack of in-depth analysis and overall situation judgment capabilities.

The shortcomings of the existing technology are as follows:
1) It is inefficient to analyze abnormal situations and evaluate system health through manual monitoring
2) For unlabeled data, there is a lack of effective models to analyze the complex correlations between indicators, making it difficult to define the health of the system.
3) The threshold-based method generates a large number of false alarms, making it impossible for operators to deal with them in time, and making the health design lack robustness.
4) The system health assessment strategy lacks multi-dimensional considerations, making it difficult to form a situational awareness of the overall system.

Therefore, the existing technology requires a method that can quickly analyze intelligent operation and maintenance system data to ensure the real-time nature of the system. At the same time, it requires a model that can capture the complex correlation between indicators to provide a priori knowledge of health. Based on the above, the weight design of anomaly detection results and expert knowledge containing complex anomaly correlations is used to achieve health assessment of intelligent operation and maintenance scenarios.

### SUMMARY OF THE INVENTION

In order to solve the above problems, the present invention provides a method for health evaluation based on intelligent operation and maintenance scenarios, and a device thereof, so as to realize the health evaluation of intelligent operation and maintenance scenarios.

The technical content of the present invention includes:
A method for health evaluation based on intelligent operation and maintenance scenarios, comprising:
collecting log data and configuration data of the operation and maintenance system;
preprocessing the log data and the configuration data to build a business key information database, wherein the data in the business key information database includes: time, configuration id, configuration target and configuration amount;
training the vector autoregressive model and the LSTM-AE (Long Short Term Memory-AutoEncoder) model respectively based on the data and labels of the configuration id in each set time interval to obtain the vector autoregressive model anomaly score and the LSTM-AE model anomaly score of each configuration id at the prediction time, wherein the label includes: the correlation impact between abnormal situations and indicators;
obtaining the anomaly score of the configuration id at the prediction time by combining the vector autoregressive model anomaly score of the configuration id at the prediction time and the LSTM-AE model anomaly score;
calculating the health of the operation and maintenance system at the predicted time based on the abnormality score of each configuration ID at the predicted time.

Further, the said preprocessing the log data and the configuration data to build a business key information database, including:
performing data cleaning on the log data and the configuration data;
applying the differential moving average method to complete the filling of missing values in the time series data in the cleaned data to obtain the time series data;
performing feature extraction on the time series data, wherein the features include: time, configuration id, configuration target and configuration amount;
building a business key information database based on the above characteristics.

Further, before the said applying the differential moving average method to complete the filling of missing values of the time series data in the cleaned data to obtain the time series data, the method also includes:
grouping the configurations by the Rabin-Karp method.
Further, the said applying differential moving average method to complete the filling of missing values of the time series data in the cleaned data to obtain the time series data, including: performing difference calculation based on the time column of the time series;
inserting a time value into the time data that does not meet the differential distance, so that the time data that does not meet the differential distance meets the timing increment requirements;
filling the time data which do not satisfy the differential distance according to the moving average interpolation method.

Further, the said training the vector autoregressive model based on the data and labels of the configuration id in each set time interval to obtain the vector autoregressive model anomaly score of each configuration id at the prediction time, including:
obtaining the predicted value of the configuration id in the set time interval t+1 by training the vector autoregressive model based on the data and labels of the configuration id in the set time interval t to;
obtaining the predicted value of the configuration id at the set time interval t+2 by adjusting the parameters of the vector autoregressive model according to the predicted value and label of the configuration id in the set time interval t+1, and training the vector autoregressive model based on the data and label of the configuration id in the set time interval t+1;
obtaining the predicted value of the configuration id at the prediction time, and calculating the residual value at the prediction time;
calculating the mean of the training data residuals and the standard deviation of the training data residuals;
calculating the indicator anomaly score=|(predicted value−true value)−the mean of the training data residuals|/the standard deviation of the training data residuals;
calculating the overall anomaly score=the Markov distance between the residual value at the prediction time and the mean residual value of the training data;
obtaining the vector autoregressive model anomaly score of the configuration id at the prediction time based on the indicator anomaly score and the overall anomaly score.

Further, the said training the LSTM-AE model based on the data and labels of the configuration id in each set time interval to obtain the LSTM-AE model anomaly score of each configuration id at the prediction time, including:
performing feature compression of the encoder on the data with the configuration ID in the set time interval t;
performing feature reconstruction of the decoder on the compressed feature data, configuring the tag with the id in the set time interval t, and adjusting the parameters of the encoder and the decoder;
performing feature compression on the data of the configuration id in the prediction time based on the trained encoder;
performing feature reconstruction on the compressed data in prediction time based on the trained decoder to obtain the reconstructed value;
using the reconstructed value as the LSTM-AE model anomaly score of the configuration id at the prediction time.

Further, the said calculating the health of the operation and maintenance system at the predicted time based on the abnormality score of each configuration ID at the predicted time, including:
classifying the configuration ID into a configuration ID that has a greater impact on the system and a configuration ID that has a smaller impact on the system based on expert knowledge;
setting the weights of configuration IDs that have a greater impact on the system and configuration IDs that have a smaller impact on the system respectively;
obtaining the health degree F. (t) of the operation and maintenance system at the prediction time based on the abnormal score of each configuration ID at the prediction time, the abnormal log statistics time, the total time of the log statistics, the abnormal configuration time, the total configuration time and the weight, wherein t represents the prediction time.

Further, the health degree

$$f ( t ) = \{ \begin{matrix}0 & g ( t ) \leq 0 \\ g ( t ) & g ( t ) > 0\end{matrix}$$

$$g ( t ) = 100 - {W}_{{J}_{1}} \cdot {\sum }_{i = 0}^{n} {J}_{1 i} - {W}_{{J}_{2}} \cdot {\sum }_{i = 0}^{n} {J}_{2 i} - \frac{{Time}_{E L}}{{Time}_{AL}} \cdot {W}_{L} - \frac{{Time}_{E P}}{{Time}_{A P}} \cdot {W}_{P}$$

wherein, J₁ᵢ indicates that the i-th configuration is unavailable and has a small impact on the system, Wⱼ₂ indicates the weight when the configuration is unavailable and has a large impact on the system, J₂ᵢ indicates that the i-th configuration is unavailable and has a large impact on the system, Time_{EL} indicates the abnormal log statistics time, Time_{AL} represents the total time of log statistics, W_{L} represents the weight of the impact of log anomalies on system health, Time_{EP} represents the abnormal configuration time, Time_{AP} represents the total time of configuration, W_{P} represents the weight of the impact of configuration anomalies on system health.

A storage medium in which a computer program is stored, wherein the computer program is configured to execute any of the above methods when a processor is running.

An electronic device, comprising a memory and a processor, a computer program is stored in the memory, wherein the processor is configured to run the computer program to perform any one of the above methods.

Compared with the existing technology, the method proposed by the present invention has the following advantages and effects:

Automatically collect, preprocess and anomaly detect the business data of the intelligent operation and maintenance system. Combining expert experience, a health evaluation method based on intelligent operation and maintenance scenarios is proposed to help operators evaluate the business system through multi-dimensional data analysis. Evaluate the overall situation, effectively improve automated operation and maintenance capabilities, and help operators process alarm information in a timely manner. It provides new ideas for subsequent research and engineering applications based on system health.

### BRIEF DESCRIPTION OF THE DRAWINGS

FIG. 1 is a flow chart of the health assessment method of the intelligent operation and maintenance business system in the present invention.

FIG. 2 is a functional diagram of the health assessment device of the intelligent operation and maintenance business system in the present invention.

### DETAILED DESCRIPTION OF THE INVENTION

The technical solutions in the embodiments of the present invention will be clearly and completely described below with reference to the accompanying drawings. Obviously, the described embodiments are only specific embodiments of the present invention, rather than all embodiments. Based on the embodiments of the present invention, all other embodiments obtained by those of ordinary skill in the art without creative efforts fall within the scope of protection of the present invention.

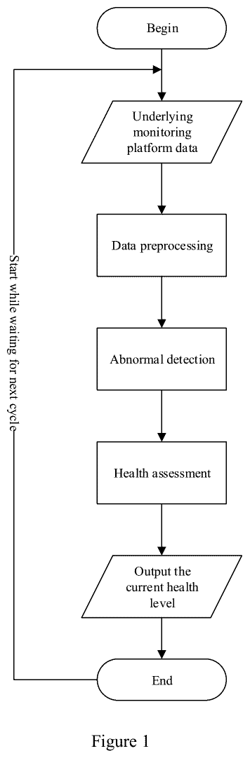

This application proposes a health evaluation method based on intelligent operation and maintenance scenarios, as shown in FIG. 1, including the following steps:

Step 1: Data Acquisition: Use Special Data Collection Equipment to Obtain Log Data and Configuration Data from the Operation and Maintenance System

When obtaining data, log in through a legal user authorized by the system, then read the data by calling the log data interface and configuration data interface and save it to a local data table for backup, and provide a data interface that can be accessed by the preprocessing module, including:
1) applying for permission to read data from the system's dedicated monitoring system.
2) setting the period for reading data (for example, 5 minutes/time) according to the characteristics of the system's data collection.
3) reading log data and configuration data and saving them in the log data statistics table and configuration data statistics table.
   Step 2: Build the Database: First, Use Data Cleaning, Data Integration, Data Transformation, Periodic Trend Decomposition, Data Clustering, Etc. To Preprocess the Log Data and Configuration Data to Build a Business-Critical Information Database.

First, the present invention performs data cleaning on the data collected by the data collection equipment based on expert experience.

Secondly, the present invention applies the differential moving average method to complete the filling of missing values in the time series data in the data.

Since most of the time series data has missing data, it is necessary to use the moving average method based on differences to detect and complete the random missing values in the configuration log data, and at the same time build normal configuration training data, which is effective for complex business systems. Missing data are preprocessed. The differential moving average method first performs differential calculation based on the time column of the time series, and inserts time values for the time data that does not meet the differential distance (that is, there are missing values) to make it meet the requirements of time series increment. Then fill in the value at this time according to the sliding average interpolation method. Its function is to ensure data standardization, preprocess the massive configuration data received, and ensure that the data is available. The advantage is that it can provide robustness to incomplete configuration log data caused by system problems, and at the same time, it can build a normal data set unsupervised according to the needs of the model.

In one example, by setting a sliding window with a length of 3, during the movement of the window, the missing value is the average of the values in the window. When there is only one value in the sliding window, the value filling ends, and continuous time series data is generated. Next, in order to ensure the accuracy of detection, the system decomposes the periodic trend of the original sequence and uses local polynomial regression fitting to retain significant features, which helps highlight important features in massive data.

In another example, in order to help operation and maintenance personnel deeply understand the effectiveness and usage effects of different configurations of a certain business, before calculating the residual amount, the present invention also uses a method based on Rabinkarp to quickly perform configuration Group analysis improves efficiency and ensures real-time detection capabilities.

Since there are many types of businesses in the intelligent operation and maintenance system, analysis of specific monitoring targets requires refined segmentation. Therefore, the method based on Rabin-Karp is used to perform cluster analysis on the configured business according to the goals. It clusters configured targets. Combined with perfect hashing technology, it reduces the processing time of massive configuration data and displays fast configuration cluster analysis results. Rabin-Karp's algorithm is a hash-based substring search algorithm. First calculate the hash value of the pattern string, and then use the same hash function to calculate the hash value of all possible M character substrings in the string and compare it with the hash value of the pattern string. If they are the same, continue to verify whether they match. Its function is target clustering, which configures control targets based on feature value clustering. Its advantage is that it performs hash operations on pattern strings and substrings in text, converts string comparisons into numerical comparisons, can handle massive configuration data, saves system overhead, and speeds up configuration clustering.

Quickly perform group analysis of configurations using Rabincup's perfect hashing method. A hash table is a data structure that directly accesses data based on key values. It records the mapping relationship between keys and storage addresses. The hash function is a function that maps key values to addresses. Using perfect hashing technology, a variety of complex businesses can be classified through the characteristic fields of different businesses. It helps operation and maintenance personnel deeply understand the effectiveness and usage effects of different configurations of a certain business. Hash query efficiency is high, helping to reduce system overhead while completing data classification. It can run smoothly under large amounts of data and has good reliability.

Finally, based on expert experience, the present invention performs feature extraction on the above-mentioned processed time series data to build a business key information database, which is used as input to the anomaly detection model. Among them, this feature refers to the data collection time, configuration id, configuration target, configuration amount and other attributes required for subsequent anomaly detection, and delete the irrelevant attributes and redundant content.

Step 3: Anomaly Detection: Use the Abnormal Configuration Detection Method of Integrated Learning to Detect the Hit Volume of Different Business Configurations in Real Time, Detect Abnormal Fluctuations and the Correlation Between Multiple Indicators, and Provide Abnormal Alarms for Abnormal Fluctuation Indicators and Time, Feedback to the Operator.

First, the present invention uses an abnormal configuration detection method based on vector autoregression. First, it uses a data statistics method to obtain log data statistics, inputs them into the vector autoregressive model, sets the detection time range of the model, and sets the tolerance of the anomaly. The model Parameter setting, real-time detection of abnormal fluctuations and the correlation between multiple indicators, and abnormal alarms for abnormal fluctuation indicators and time, and feedback to the operator. Specifically, it captures correlations between configuration data. If there is a certain correlation between vectors, then the observed value of the indicator at the previous moment has a predictive relationship with the observed value at the next moment.

In one example, the vector autoregression method is used to detect abnormal times and abnormal configurations. It mainly conducts model training through the data of the prediction target in the time series data for a period of time ago, predicts the value of the indicator at the next moment based on the training results, and recursively until the set prediction time. For a certain moment:

The anomaly score of the indicator=|(predicted value−true value)−the mean of the training data residuals|/the standard deviation of the training data residuals;

Overall anomaly score=Markov distance between the current residual and the mean of the training data residuals.

The larger the overall anomaly score is, the more abnormal the moment is. In time series, the model is optimized by minimizing the value of white noise, and the predicted value is estimated through the least squares principle. It can make good use of the correlation between indicators to predict time series data. Its function is feature extraction and timing detection, obtaining correlation information between configuration data and using the least squares method for anomaly detection. It is lightweight and interpretable. The advantage is that the statistics-based anomaly detection algorithm treats all variables as endogenous variables and can well mine the correlation features between configuration data.

Secondly, the anomaly detection method based on LSTM-AE is used to detect the configuration fluctuation anomaly. Under unsupervised conditions, the model lacks a learning objective. To address this problem, the automatic encoding machine sets the learning target of the model to the configuration data itself, and learns the main features and patterns of the configuration by mapping the configuration data to a lower-dimensional feature space. Then the learned model can be based on the main features. Refactor the configuration. Among them, the module that maps the configuration to the low-dimensional feature space is the encoder, and the module that reconstructs the configuration based on the main features is the decoder. Its specific implementation plan is as follows:
(1) First, perform feature compression on the processed real configuration values of the business key information database. The encoder used has a network structure of LSTM.
(2) Then, perform decoder feature reconstruction on the compressed feature data to obtain the reconstructed value. The decoder network structure used is LSTM.
(3) Anomaly detection based on the difference between the real value and the reconstructed value

The autoencoder will generate errors during the process of decoding and reconstructing the encoded features. The principle of training an autoencoder is to use backpropagation to minimize the reconstruction error. In the training phase, normal data are input into the autoencoder, and the autoencoder learns the hidden features and patterns of the normal data by reducing the mean square error between the reconstructed data and the original data. Therefore, in the testing phase, the reconstruction error of normal configuration is relatively small, while the reconstruction error of abnormal configuration is relatively large (because the model has not learned the implicit characteristics and patterns of abnormal samples). Therefore, the reconstruction error is taken as the anomaly score for this configuration.

Finally, the anomaly detection results of the above-mentioned vector autoregression-based and LSTM-AE-based anomaly detection methods are comprehensively analyzed to obtain indicators of configuration fluctuation anomalies and abnormal fluctuation time.

### Step 4: System Health Assessment: Use a Method Based on Anomaly Detection and Category Weights, and Calculate the Health of the Entire Business System Through Category Weight Design Based on Anomaly Detection Results and Expert Experience.

The present invention is based on the above-mentioned detection results and expert knowledge, and uses the health calculation formula f(t) to calculate the health of the system in this period. Specifically, the anomaly detection results based on the integrated model are combined to obtain the anomaly score of the configuration business, in which the configuration content with greater and less impact on the system is constructed based on expert knowledge;
1) Obtain business configuration weights preset by expert knowledge;
2) Estimate the overall health of the business system through the following system health model.

$$g ( t ) = 100 - {W}_{{J}_{1}} \cdot {\sum }_{i = 0}^{n} {J}_{1 i} - {W}_{{J}_{2}} \cdot {\sum }_{i = 0}^{n} {J}_{2 i} - \frac{{Time}_{E L}}{{Time}_{AL}} \cdot {W}_{L} - \frac{{Time}_{E P}}{{Time}_{A P}} \cdot {W}_{P}$$

$$f ( t ) = \{ \begin{matrix}0 & g ( t ) \leq 0 \\ g ( t ) & g ( t ) > 0\end{matrix}$$

f(t) Indicates the health function of the intelligent operation and maintenance system, g(t) Indicates the intermediate process function of the health of the intelligent operation and maintenance system, W_{J}_{₁} Indicates the weight of the hours of impact that configuration unavailability has on the system, J₁ᵢ Indicates that the i-th configuration is unavailable and has little impact on the system, W_{J}_{₂} Indicates the weight when the configuration is unavailable and has a great impact on the system, J₂ᵢ Indicates that the i-th configuration is unavailable and has a great impact on the system, Time_{EL} Indicates the abnormal log statistics time, Time_{AL} Indicates the total time of log statistics, W_{L} Indicates the weight of the impact of log anomalies on system health, Time_{EP} Indicates abnormal configuration time, Time_{AP} Represents the total time of configuration, W_{P} Indicates the weight of the impact of configuration anomalies on system health.

To sum up, in view of the instability of the intelligent operation and maintenance system business, the present invention can obtain the intelligent operation and maintenance system within this period after a cycle of data collection, data processing, anomaly detection, and health assessment calculation through the above steps. The system health status provides an adjustable business weight interface, which can adjust the weight according to the actual situation to ensure the effectiveness of the overall assessment of the system's situation.

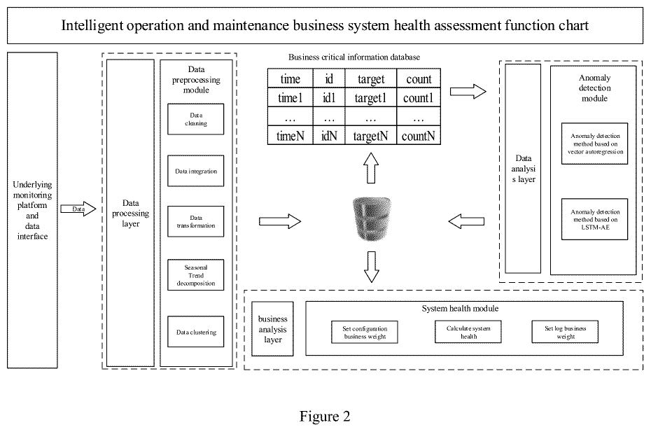

The present invention also provides a health evaluation device based on intelligent operation and maintenance scenarios. The functional diagram of the device is shown in FIG. 2. The functions of the system are realized by the underlying monitoring platform and data interface, data preprocessing module, business analysis module, It is composed of anomaly detection module and system health module.

The above embodiments are only used to illustrate the technical solutions of the present invention but not to limit them. Those of ordinary skill in the art can modify or equivalently replace the technical solutions of the present invention without departing from the spirit and scope of the present invention. The scope of protection shall be determined by the claims.

1. A method for health evaluation based on intelligent operation and maintenance scenarios, comprising:
collecting log data and configuration data of the operation and maintenance system;
preprocessing the log data and the configuration data to build a business key information database, wherein the data in the business key information database includes: time, configuration id, configuration target and configuration amount;
training the vector autoregressive model and the LSTM-AE model respectively based on the data and labels of the configuration id in each set time interval to obtain the vector autoregressive model anomaly score and the LSTM-AE model anomaly score of each configuration id at the prediction time, wherein the label includes: the correlation impact between abnormal situations and indicators;
obtaining the anomaly score of the configuration id at the prediction time by combining the vector autoregressive model anomaly score of the configuration id at the prediction time and the LSTM-AE model anomaly score;
calculating the health of the operation and maintenance system at the predicted time based on the abnormality score of each configuration ID at the predicted time.

2. The method according to claim 1, wherein the said preprocessing the log data and the configuration data to build a business key information database includes:
performing data cleaning on the log data and the configuration data;
applying the differential moving average method to complete the filling of missing values in the time series data in the cleaned data to obtain the time series data;
performing feature extraction on the time series data, wherein the features include: time, configuration id, configuration target and configuration amount;
building a business key information database based on the above characteristics.

3. The method according to claim 2, wherein before the said applying the differential moving average method to complete the filling of missing values of the time series data in the cleaned data and obtaining the time series data, the method also includes:
grouping the configurations by the Rabin-Karp method.

4. The method according to claim 2, wherein the said applying the differential moving average method to complete the filling of missing values of the time series data in the cleaned data to obtain the time series data includes:
performing difference calculation based on the time column of the time series;
inserting a time value into the time data that does not meet the differential distance, so that the time data that does not meet the differential distance meets the timing increment requirements;
filling time data that does not satisfy the differential distance according to the moving average interpolation method.

5. The method according to claim 1, wherein the said training the vector autoregressive model based on the data and labels of the configuration id in each set time interval to obtain the vector autoregressive model anomaly score of each configuration id at the prediction time, further includes:
obtaining the predicted value of the configuration id in the set time interval t+1 based on the data and label training vector autoregressive model of the configuration id in the set time interval t;
obtaining the predicted value of the configuration id at the set time interval t+2 by adjusting the parameters of the vector autoregressive model according to the predicted value and label of the configuration id in the set time interval t+1, and training the vector autoregressive model based on the data and labels of the configuration id in the set time interval t+1;
obtaining the predicted value of the configuration id at the prediction time, and calculating the residual value at the prediction time;
calculating the mean of the training data residuals and the standard deviation of the training data residuals;
calculating the indicator anomaly score=|(predicted value−true value)−the mean of the training data residuals|/the standard deviation of the training data residuals;
calculating the overall anomaly score=the Markov distance between the residual value at the prediction time and the mean residual value of the training data;
obtaining the vector autoregressive model anomaly score of the configuration id at the prediction time based on the indicator anomaly score and the overall anomaly score.

6. The method according to claim 1, wherein the said training the LSTM-AE model based on the data and labels of the configuration id in each set time interval to obtain the LSTM-AE model anomaly scores of each configuration id at the prediction time, includes:
performing feature compression of the encoder on the data with the configuration ID in the set time interval t;
performing feature reconstruction of the decoder on the compressed feature data, configuring the tag with the id in the set time interval t, and adjusting the parameters of the encoder and the decoder;
performing feature compression on the data of the configuration id in the prediction time based on the trained encoder;
performing feature reconstruction on the compressed data in prediction time to obtain the reconstructed value based on the trained decoder;
using the reconstructed value as the LSTM-AE model anomaly score of the configuration id at the prediction time.

7. The method according to claim 1, wherein the said calculating the health of the operation and maintenance system at the predicted time based on the abnormality score of each configuration ID at the predicted time includes:
classifying the configuration ID into a configuration ID that has a greater impact on the system and a configuration ID that has a smaller impact on the system based on expert knowledge;
setting the weights of configuration IDs that have a greater impact on the system and configuration IDs that have a smaller impact on the system respectively;
obtaining the health degree f(t) of the operation and maintenance system at the prediction time based on the abnormal score of each configuration ID at the prediction time, the abnormal log statistics time, the total time of the log statistics, the abnormal configuration time, the total configuration time and the weight, wherein t represents the prediction time.

8. The method according to claim 7, wherein the health degree
$$f ( t ) = \{ \begin{matrix}0 & g ( t ) \leq 0 \\ g ( t ) & g ( t ) > 0\end{matrix}$$
$$g ( t ) = 100 - {W}_{{J}_{1}} \cdot {\sum }_{i = 0}^{n} {J}_{1 i} - {W}_{{J}_{2}} \cdot {\sum }_{i = 0}^{n} {J}_{2 i} - \frac{{Time}_{E L}}{{Time}_{AL}} \cdot {W}_{L} - \frac{{Time}_{E P}}{{Time}_{A P}} \cdot {W}_{P}$$
wherein, J₁ᵢ indicates that the i-th configuration is unavailable and has a small impact on the system, Wⱼ₂ indicates the weight when the configuration is unavailable and has a large impact on the system, J₂ᵢ indicates that the i-th configuration is unavailable and has a large impact on the system, Time_{EL} indicates the abnormal log statistics time, Time_{AL} represents the total time of log statistics, W_{L} represents the weight of the impact of log anomalies on system health, Time_{EP} represents the abnormal configuration time, Time_{AP} represents the total time of configuration, W_{P} represents the weight of the impact of configuration anomalies on system health.

9. A storage medium in which a computer program is stored, wherein the computer program is configured to execute the method claim 1 when running.

10. An electronic device, comprising a memory and a processor, a computer program stored in the memory, wherein the processor being configured to run the computer program to perform the method according to claim 1.
